(19) United States
(12) Patent Application Publication
(10) Pub. No.: US 2014/0341789 A1
(43) Pub. Date: Nov. 20, 2014

(54) STIRRING DEVICE AND AUTOMATIC ANALYSIS APPARATUS

(71) Applicants: Kabushiki Kaisha Toshiba, Minato-ku (JP); Toshiba Medical Systems Corporation, Otawara-shi (JP)

(72) Inventors: Xinmin WANG, Dalian (CN); Xin Li, Dalian (CN)

(73) Assignees: Kabushiki Kaisha Toshiba, Minato-ku (JP); Toshiba Medical Systems Corporation, Otawara-shi (JP)

(21) Appl. No.: 14/447,077

(22) Filed: Jul. 30, 2014

Related U.S. Application Data
(63) Continuation of application No. PCT/JP2013/052017, filed on Jan. 30, 2013.

(30) Foreign Application Priority Data
Jan. 30, 2012 (CN) 201210021128.7

(51) Int. Cl. B01F 11/00; B01F 15/00; B01F 13/08

(52) U.S. Cl. CPC B01F 11/0062; B01F 13/0827; B01F 15/00331; B01F 2215/0037
USPC 422/554

(57) ABSTRACT

According to one embodiment, an automatic analysis apparatus comprises a stirrer, a moving unit, a vibrating unit, and a control unit. The stirrer is configured to stir a solution mixture which includes a sample of a specimen and a reagent corresponding to a measurement item of the specimen, and is stored in a reaction cuvette. The moving unit is configured to move the stirrer in a first direction as a depth direction of the reaction cuvette. The vibrating unit is configured to vibrate the stirrer in a second direction different from the first direction. The control unit is configured to control the moving unit and the vibrating unit, such that the stirrer moves in the first direction while vibrating in the second direction.

### CROSS-REFERENCE TO RELATED APPLICATIONS

This application is a Continuation Application of PCT Application No. PCT/JP2013/052017, filed Jan. 30, 2013 and based upon and claiming the benefit of priority from the Chinese Patent Application No. 201210021128.7, filed Jan. 30, 2012, the entire contents of which are incorporated herein by reference.

### FIELD

Embodiments described herein relate generally to a stirring device and an automatic analysis apparatus including the stirring device.

### BACKGROUND

Stirring devices are used in many fields, and applied to sample analysis apparatuses such as an automatic analysis apparatus (biochemical analyzer). In a mechanical stirring device, a spiral stirrer easily moves in a sample vessel and has a high stirring effect, but is not easy to wash. To facilitate washing (especially when frequently using a stirrer to stir different samples), an oscillation type stirrer having a simple shape, e.g., a flat shape is often used.

FIG. 5 is a view showing a conventional oscillation type stirrer having a simple shape. A stirrer 102 is formed on a substrate 106. An oscillating mechanism 104 (e.g., a piezoelectric member) as a driving source oscillates the stirrer 102. Referring to FIG. 5, the stirrer 102 can oscillate in a direction approximately perpendicular to the drawing surface.

When the stirrer 102 oscillates, the oscillation width of the free end, i.e., the lower end is obviously larger than the vibration width of the root of the piezoelectric member, and the vibration width gradually decreases toward the root of the free end. Accordingly, the stirring effect is mainly generated by the free end having a large oscillation width.

Unfortunately, when various components of samples have different properties or when sample liquid surfaces have different heights in sample vessels, it is difficult to sufficiently stir a sample so as to uniformly mix it, by the oscillation of the free end of the stirrer shown in FIG. 5.

It is an object of the embodiment of the present invention to provide a stirring device that has a high stirring ability and is easy to wash, and an automatic analysis apparatus including the stirring device.

### BRIEF DESCRIPTION OF THE DRAWINGS

FIG. 1 is a view showing a stirring device based on one embodiment.

FIG. 2 is a view showing a stirring device based on another embodiment.

FIG. 3 is a view showing a stirring device based on another embodiment.

FIG. 4 is a view showing stirring devices according to this embodiment to be used in an automatic analysis apparatus.

FIG. 5 is a view showing a conventional stirring device.

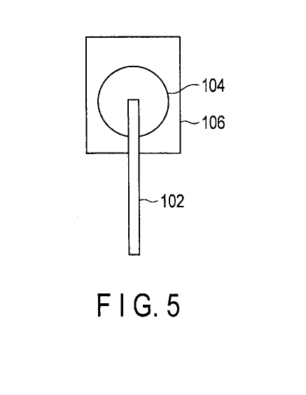

### DETAILED DESCRIPTION

In general, according to one embodiment, an automatic analysis apparatus comprises a stirrer, a moving unit, a vibrating unit, and a control unit. The stirrer is configured to stir a solution mixture which includes a sample of a specimen and a reagent corresponding to a measurement item of the specimen, and is stored in a reaction cuvette. The moving unit is configured to move the stirrer in a first direction as a depth direction of the reaction cuvette. The vibrating unit is configured to vibrate the stirrer in a second direction different from the first direction. The control unit is configured to control the moving unit and the vibrating unit, such that the stirrer moves in the first direction while vibrating in the second direction.

The object, features, and merits of this embodiment can be understood more easily by explaining the embodiment with reference to the accompanying drawings. Arrangements in these drawings solely indicate the principle of this embodiment. In the drawings, identical or similar technical features or arrangements will be expressed by using identical or similar figures.

This embodiment will be explained below with reference to the drawings. Note that in the following explanation, arrangements and features described in one drawing or one embodiment can be combined with arrangements and features described in another drawing or a plurality of other drawings or in another embodiment or a plurality of other embodiments. Many requirements necessary to determine an actual embodiment of any kind during the process of developing the embodiment implement a practical object of the developer. For example, these requirements agree with limiting conditions related to a system or business, and these limiting conditions can be altered in accordance with the embodiment. Furthermore, the development is complicated and may require a lot of time and effort, but a profit to be brought to those skilled in the art based on contents disclosed by this application is nothing but a stereotypical duty of the development.

To clarify the explanation, contents irrelevant to this embodiment and arrangements and processes well known to those skilled in the art will be neither shown nor described in the drawings and explanation.

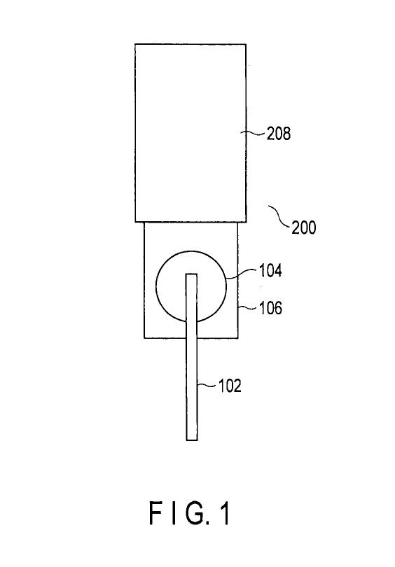

FIG. 1 is a view showing a stirring device 200 based on one embodiment of the present invention. The stirring device 200 is typically used when stirring a solution mixture including a sample and reagent in a reaction cuvette of an automatic analysis apparatus (an apparatus that automates the procedure of mixing a reagent in a sample (specimen) of a liquid, urine, a body fluid such as a cerebrospinal fluid, or a tissue, and analyzing and examining components by checking reactions by using light). The operation of the stirring device 200 is controlled in accordance with commands from a processor installed in the stirring device 200, or a central control unit of the automatic analysis apparatus.

The stirring device 200 includes a stirrer 102, an oscillating mechanism 104 for oscillating the stirrer 102 in a transverse-axis direction, and a reciprocating mechanism 208 for vertically reciprocating the stirrer 102. The “transverse-axis direction” herein mentioned is a direction approximately perpendicular to the longitudinal direction of the stirrer 102. In other words, the transverse-axis direction is a direction in an approximately horizontal plane. For example, when the oscillating mechanism 104 is a piezoelectric member and this piezoelectric member is arranged in the direction of the drawing surface of FIG. 1, the stirrer 102 oscillates in a direction perpendicular to the direction of the drawing surface.

The principle of the oscillation is as follows. The stirrer 102 itself has a predetermined softness (i.e., a relatively low rigidity), and has a long narrow shape. The stirrer has a rational rigidity, length, and weight, and the vibration frequency of a vibration source (i.e., the oscillating mechanism 104), and generates resonance at the free end, i.e., the lower end of the stirrer, thereby realizing vibration having a vibration width larger than at least the vibration width of the vibration source. That is, the root of the stirrer 102, which is connected to the vibration source, realizes an oscillatory motion, thereby giving a relatively high stirring ability to the lower end of the stirrer.

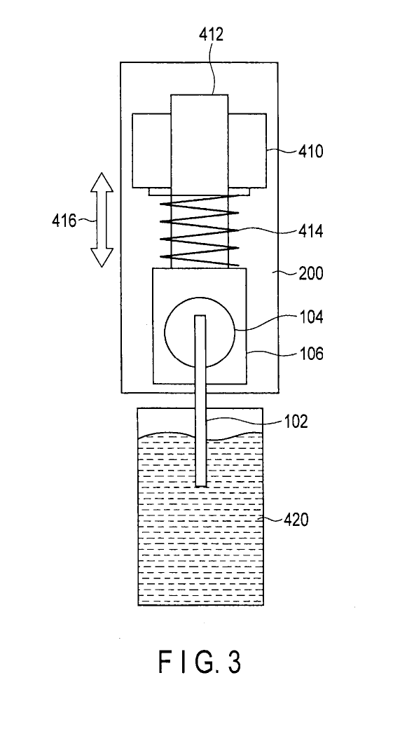

The vibration source is a device capable of realizing any vibration, e.g., an electromagnetic mechanism or piezoelectric member that is driven by a DC pulse or alternating current. As shown in FIG. 1 or 3, the piezoelectric member connected to the stirrer 102 and one end (i.e., the upper end) of the stirrer 102 are fixed on the piezoelectric member, and the vibration source (oscillating mechanism 104) is vibrated by driving the piezoelectric member. The length, rigidity, and weight of the stirrer 102 and the vibration frequency of the piezoelectric member are set such that the other end of the stirrer resonates by the vibration of the above-mentioned one end, thereby realizing vibration larger than the vibration width of the piezoelectric member. That is, the whole stirrer 102 oscillates. Note that as the oscillation period of the stirrer 102 (i.e., the vibration frequency of the piezoelectric member), it is possible to adopt, e.g., 40 to 60 Hz, and preferably, 50 Hz.

As described in “Background”, when the stirrer 102 oscillates, the oscillation width of the free end, i.e., the lower end is obviously larger than that of the root of the piezoelectric member, and the oscillation width gradually decreases from the free end to the root. Therefore, the stirring effect is mainly obtained by the free end having a large oscillation width. Accordingly, even a liquid in which upper and lower layers have different densities can be stirred to be evenly mixed.

When this is taken into consideration, this embodiment includes the reciprocating mechanism 208, and the reciprocating mechanism 208 transmits power to the substrate 106, thereby realizing a reciprocal motion in a vertical direction 416 of the stirrer 102 on the substrate 106. In addition, the lower end of the stirrer 102 executes stirring even when the heights of samples to be stirred are different, so it is possible to sufficiently stir all samples. Note that as the period of the reciprocal motion of the stirrer 102 in the vertical direction 416 (i.e., the vibration frequency of the piezoelectric member), it is possible to adopt, e.g., 40 to 60 Hz, and preferably, 50 Hz. Note also that the period and amplitude of the reciprocal motion of the stirrer 102 in the vertical direction 416 can be controlled independently of or in synchronism with the period and amplitude of the oscillation.

The reciprocating mechanism 208 is a mechanism capable of realizing any reciprocal motion, e.g., a linear motor (linear electric motor) or piezoelectric device. FIG. 3 shows an embodiment showing an electromagnetic reciprocating mechanism, but this mechanism is merely an example, and the embodiment of the present invention is not limited to this. For example, the aforementioned reciprocating mechanism may also be a reciprocating mechanism using a piezoelectric member.

More specifically, as shown in FIG. 3, this electromagnetic reciprocating mechanism includes an electromagnet 410, armature 412, and spring 414. The armature 412 is connected to the oscillating mechanism 104 and the substrate 106 for fixing the stirrer 102. It is, of course, also possible to directly fix the oscillating mechanism 104 and stirrer 102 on the armature 412, and the armature vertically moves the stirrer 102. In this case, the armature 412 is equivalent to the oscillating mechanism 104 and the substrate of the stirrer 102. The electromagnet 410 excites a DC pulse or alternating current, and vertically reciprocates the armature 412 together with the spring 414, thereby vertically reciprocating the stirrer 102 as well. Since the lower end of the stirrer 102 realizes stirring at different depths of a sample 420, a better stirring effect can be obtained.

In accordance with the features of sample stirring, it is possible to rationally determine, e.g., the frequency for exciting the DC pulse or alternating current of the electromagnet, and the natural frequencies, weights, and lengths of the spring 414 and armature 412, and determine an appropriate vertical motion frequency and amplitude of the stirrer. Likewise, in accordance with the features of sample stirring, it is possible to rationally determine the frequency for exciting the DC pulse or alternating current of the oscillating mechanism, e.g., the piezoelectric member, and the natural frequency of the stirrer (determined as the aforementioned rigidity, length, weight, and the like of the stirrer), and determine an appropriate oscillation frequency and amplitude of the stirrer.

Also, the vertical motion frequency and amplitude of the stirrer and/or the frequency and amplitude of the stirrer need not be fixed and may also be variable. For example, it is also possible to change the frequency and intensity for exciting the DC pulse or alternating current of the electromagnetic and/piezoelectric member, in accordance with the characteristics of an object to be stirred, e.g., the amount, the presence/absence of foamability, and the viscosity. For example, when the liquid amount of a solution mixture including a sample and reagent and requiring stirring is relatively small, or when using a reagent having foamability, it is possible to effectively perform stirring by realizing a small-width oscillatory motion or vertical motion. Also, the lather and stirring effect change when a solution mixture is a surfactant or in accordance with the viscosity of a solution mixture. Accordingly, it is favorable to control the amplitudes and periods of the oscillatory motion and vertical motion in accordance with the properties such as the lather and viscosity. Note that the viscosity of a sample or reagent can also be measured when performing suction by using a dispensing probe of an automatic analysis apparatus.

The above-mentioned properties of a solution mixture including a sample and reagent depend on the sample in many cases, and have a correspondence relation to a measurement item. Therefore, it is also possible to change the frequency and intensity for exciting the DC pulse or alternating current of the electromagnetic and/piezoelectric member, in accordance with a measurement item. Furthermore, it is possible to allow a user to freely select a plurality of stirring strengths by making it possible to set a plurality of combinations of the period and amplitude of the reciprocal motion of the stirrer 102 in the vertical direction 416, and the period and amplitude of the oscillation. In addition, the vertical direction 416 of the stirrer 102 may also be turned on/off in accordance with a measurement item. These control operations for the stirring operation are executed based on a program and data stored in a memory, in accordance with commands from the processor installed in the stirring device 200 or the central control unit of the automatic analysis apparatus.

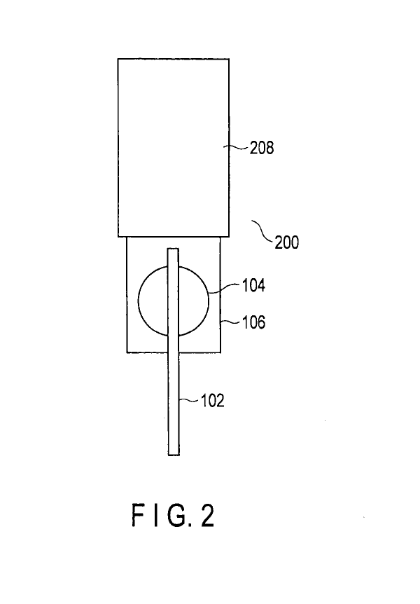

FIG. 2 is a view showing a modification of the above-described embodiments. In this modification, the oscillating mechanism 104 includes a piezoelectric member connected to the stirrer 102, one end (the upper end) of the stirrer 102 is fixed on the substrate 106 above the piezoelectric member, and the lower portion of the one end of the stirrer is fixed on the piezoelectric member and oscillated when the piezoelectric member is driven. The whole stirrer 102 is equivalent to a “lever” having the above-mentioned one end as a fulcrum, and the other end (lower end) of the stirrer 102 increases the vibration of the piezoelectric member, thereby realizing vibration larger than the vibration width of the piezoelectric member at the other end. That is, the stirrer 102 realizes an oscillatory motion. The piezoelectric member may also be another typical oscillating mechanism, e.g., an electromagnetic mechanism.

It is obviously possible to combine “the principle of leverage” in the above-described modification to the combination of the methods of generating resonance at the lower ends of the stirrers shown in FIGS. 1 and 3, and the lower end of the stirrer 102 can easily generate oscillation having a necessary amplitude.

The various embodiments of the above-mentioned stirring device can achieve a sufficient stirring action not only in the transverse-axis direction but also in the vertical direction, and can achieve stirring at different depths in a sample, thereby obtaining a better stirring effect. In addition, since stirring is obtained by vibration, the stirrer need only have a simple shape, i.e., need not have any spiral shape, and hence can easily be washed.

The above-mentioned stirring device is applicable to various situations requiring stirring at different heights. For example, the stirring device demonstrates power especially in a situation in which it is necessary to frequently wash the stirrer, e.g., when performing analysis by using an automatic sample analysis apparatus that continuously analyzes large amounts of samples. For example, the stirring device can be applied to stir a sample (e.g., a blood or urine) in a biochemical analyzer. When deposition or component separation occurs in a sample such as a blood or urine including different components after the elapse of a predetermined time, stirring must be performed at different heights in a sample vessel. At the same time, large amounts of samples must be analyzed in a biochemical analyzer for analyzing samples such as a blood and urine (for example, it is necessary to examine bloods and urines of many patients at once in a hospital, and analyze many examination items for each sample). Therefore, it is necessary to frequently wash the stirrer.

Also, the driving control of the vertical reciprocating motion of the stirrer is executed not only when stirring a solution mixture, but also when washing the stirrer in a washing tank. This makes it possible to improve the washing efficiency of the stirrer.

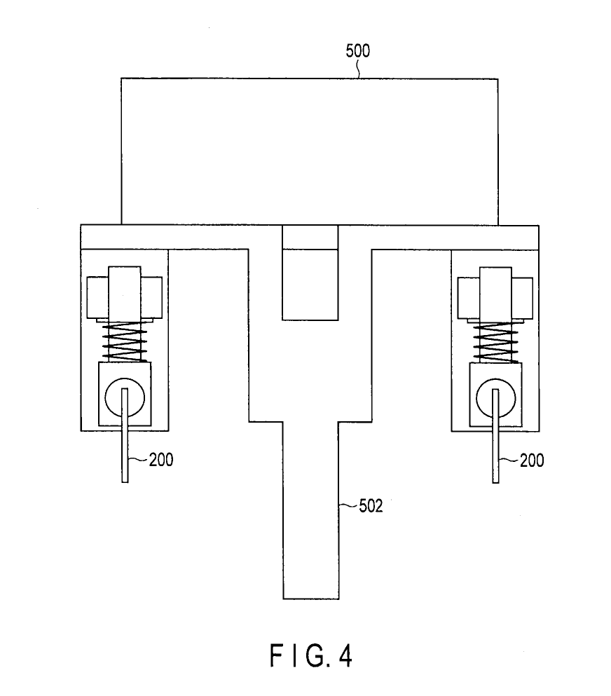

FIG. 4 is a view showing a local portion of a sample analyzer 500. In the sample analyzer 500, a plurality of stirring devices 200 (two devices are exemplarily shown) are fixed on a column 502, and sample vessels (not shown) are arranged below the stirring devices. When the column 502 moves downward, it is possible to simultaneously stir samples in the plurality of sample vessels. This arrangement shown in FIG. 4 is merely an example, and does not impose any limitation on the sample analyzer 500.

Note that in the above-mentioned embodiments, the stirrer 102 is reciprocated along the vertical direction 416 while it is oscillated. However, the stirrer 102 need not be reciprocated along the vertical direction 416 depending on a measurement item. For example, the stirrer 102 need only be moved upward or downward while it is oscillated.

Also, when terms “include/contain” are used in this embodiment, these terms indicate the existence of a process, method, arrangement, or structure. However, this does not exclude the existence and addition of another process, method, arrangement, or structure. In addition, an element limited by words “includes one of . . . ” under a situation not having many limitations does not exclude any similar element existing in the process, method, arrangement, or structure of the element.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An automatic analysis apparatus comprising:
a stirrer configured to stir a solution mixture which includes a sample of a specimen and a reagent corresponding to a measurement item of the specimen, and is stored in a reaction cuvette;
a moving unit configured to move the stirrer in a first direction as a depth direction of the reaction cuvette;
a vibrating unit configured to vibrate the stirrer in a second direction different from the first direction; and
a control unit configured to control the moving unit and the vibrating unit, such that the stirrer moves in the first direction while vibrating in the second direction.

2. The automatic analysis apparatus according to claim 1, wherein the moving unit comprises:
an electromagnet;
an electromagnetic mechanism configured to move the stirrer from a first position to a second position along the depth direction by supplying an electric current to the electromagnet; and
an elastic member configured to move the stirrer from the second position to the first position by a recovering force, when the supply of the electric current to the electromagnet is stopped.

3. The automatic analysis apparatus according to claim 1, wherein
the vibrating unit vibrates the stirrer by applying a voltage to a piezoelectric element, and
the control unit controls the moving unit and the vibrating unit, such that a movement period of the stirrer in the first direction and a vibration period of the stirrer in the second direction are synchronized.

4. The automatic analysis apparatus according to claim 1, wherein the control unit controls the moving unit and the vibrating unit, such that at least one of a movement period of the stirrer in the first direction and a vibration period of the stirrer in the second direction changes in accordance with the measurement item.

5. The automatic analysis apparatus according to claim 1, wherein the control unit controls the moving unit and the vibrating unit, such that at least one of a movement amplitude of the stirrer in the first direction and a vibration amplitude of the stirrer in the second direction changes in accordance with the measurement item.

6. The automatic analysis apparatus according to claim 1, wherein the control unit controls ON/OFF of the movement of the stirrer in the first direction in accordance with the measurement item.

7. The automatic analysis apparatus according to claim 1, further comprising a selecting unit configured to select, for one measurement item, a predetermined one of a plurality of combinations of a movement period of the stirrer in the first direction and a vibration period of the stirrer in the second direction,
wherein the control unit controls the moving unit and the vibrating unit in accordance with the selected combination of the movement period of the stirrer in the first direction and the vibration period of the stirrer in the second direction.

8. A stirring device comprising:
a stirrer configured to stir a solution mixture which includes a sample of a specimen and a reagent corresponding to a measurement item of the specimen, and is stored in a reaction cuvette;
a moving unit configured to move the stirrer in a first direction as a depth direction of the reaction cuvette;
a vibrating unit configured to vibrate the stirrer in a second direction different from the first direction; and
a control unit configured to control the moving unit and the vibrating unit, such that the stirrer moves in the first direction while vibrating in the second direction.

9. The stirring device according to claim 8, wherein the moving unit comprises:
an electromagnet;
an electromagnetic mechanism configured to move the stirrer from a first position to a second position along the depth direction by supplying an electric current to the electromagnet; and
an elastic member configured to move the stirrer from the second position to the first position by a recovering force, when the supply of the electric current to the electromagnet is stopped.

10. The stirring device according to claim 8, wherein
the vibrating unit vibrates the stirrer by applying a voltage to a piezoelectric element, and
the control unit controls the moving unit and the vibrating unit, such that a movement period of the stirrer in the first direction and a vibration period of the stirrer in the second direction are synchronized.

11. The stirring device according to claim 8, wherein the control unit controls the moving unit and the vibrating unit, such that at least one of a movement period of the stirrer in the first direction and a vibration period of the stirrer in the second direction changes in accordance with the measurement item.

12. The stirring device according to claim 8, wherein the control unit controls the moving unit and the vibrating unit, such that at least one of a movement amplitude of the stirrer in the first direction and a vibration amplitude of the stirrer in the second direction changes in accordance with the measurement item.

13. The stirring device according to claim 8, wherein the control unit controls ON/OFF of the movement of the stirrer in the first direction in accordance with the measurement item.

14. The stirring device according to claim 8, further comprising a selecting unit configured to select, for one measurement item, a predetermined one of a plurality of combinations of a movement period of the stirrer in the first direction and a vibration period of the stirrer in the second direction,
wherein the control unit controls the moving unit and the vibrating unit in accordance with the selected combination of the movement period of the stirrer in the first direction and the vibration period of the stirrer in the second direction.
